(19) United States
(12) Patent Application Publication
(10) Pub. No.: US 2026/0117093 A1
(43) Pub. Date: Apr. 30, 2026

(54) LUMINESCENT ADHESIVE DECORATION FOR HOROLOGY COMPONENTS

(71) Applicant: The Swatch Group Research and Development Ltd, Marin (CH)

(72) Inventors: Nicolas FRANÇOIS, Neuchâtel (CH); Nathalie TERES, Bôle (CH); Benjamin CHARTREL, St-Blaise (CH)

(73) Assignee: The Swatch Group Research and Development Ltd, Marin (CH)

(21) Appl. No.: 19/333,827

(22) Filed: Sep. 19, 2025

(30) Foreign Application Priority Data
Oct. 24, 2024 (EP) 24208575.1

(51) Int. Cl. C09J 7/25; C09J 7/24; C09K 11/02; C09K 11/74; C09K 11/77

(52) U.S. Cl. CPC C09J 7/25; C09J 7/245; C09K 11/02; C09K 11/745; C09K 11/7734; C09J 2301/122; C09J 2301/41

(57) ABSTRACT

A luminescent adhesive (1) for horology components including: a first layer (10) of an adhesive material; a second layer (11), referred to as the intermediate layer, including a binder loaded with between 10% and 80% by mass of a phosphorescent pigment emitting in the UVA spectrum; and a third layer (12), semi-transparent to UV rays, including a binder loaded with between 10% and 50% by mass of a phosphorescent pigment emitting in the visible spectrum.

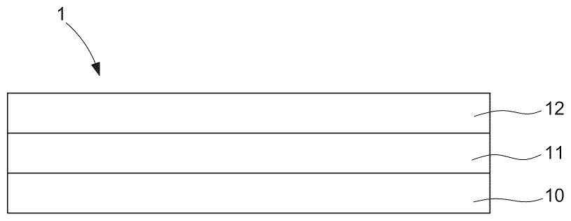

### CROSS-REFERENCE TO RELATED APPLICATIONS

This application claims priority to European Patent Application No. 24208575.1, filed on Oct. 24, 2024, the entire contents of which are incorporated herein by reference.

### TECHNICAL FIELD OF THE INVENTION

The present invention relates to a luminescent adhesive decoration for horology components.

### TECHNOLOGICAL BACKGROUND

Horological dials already commonly feature decorative elements added to one of their faces to form hour symbols.

A first technique for manufacturing these dials consists of securing the decorative elements, generally appliques, each having at least one foot that is driven into a hole pierced in the dial. However, this technique has the drawback of requiring the production and handling of numerous very small parts, which requires skilled labour and leads to high production costs.

Another conventional technique for securing decorative elements with a flat base surface consists of using a liquid or semi-liquid glue to glue the decorative elements by their base surface into recesses milled into the thickness of the dial at predetermined locations. Although less expensive than the previous technique, this method has many drawbacks.

Indeed, a first drawback is that gluing decorative elements is difficult to automatise due to the small size of the decorative elements in question. Each decorative element has to be glued on by hand, which significantly increases the manufacturing costs of these dials.

A second drawback is that it is difficult to accurately measure the amount of glue to be deposited in each recess in order to achieve satisfactory gluing.

### SUMMARY OF THE INVENTION

The present invention aims to remedy the aforementioned and other problems by providing a luminescent adhesive decoration.

To this end, the invention relates to a luminescent adhesive for horology components comprising:
a first layer of an adhesive material;
a second layer, referred to as the intermediate layer, comprising a binder loaded with between 10% and 80% by mass of a phosphorescent pigment emitting in the UVA spectrum;
a third layer comprising a binder loaded with between 10% and 50% by mass of a phosphorescent pigment emitting in the visible spectrum.

According to other advantageous variants of the invention:
the third layer is semi-transparent to UV light;
the first layer is an epoxy, an acrylic, a polyurethane or a rubber solvent;
the phosphorescent pigment emitting in the UVA spectrum exhibits an emission peak at a wavelength comprised between 300 nm and 400 nm;
the first layer has a thickness comprised between 20 μm and 200 μm;
the second layer has a thickness comprised between 50 μm and 500 μm;
the third layer has a thickness comprised between 50 μm and 500 μm;
the phosphorescent pigment emitting in the visible spectrum is strontium aluminate (SrAl2O4) spiked with europium (Eu2+) or with dysprosium (Dy3+);
the phosphorescent pigment emitting in the UVA spectrum is a compound such as LiScGeO4:Bi3+, LiYGeO4:Bi3+, Sr2MgGe2O7:Pb2+, NaLuGeO4:Bi3+, or CaMgGeO4:Bi3+;
the second layer has a greater thickness than the third layer;
the binder of the second layer and of the third layer is polyvinyl chloride or polyurethane.

### BRIEF DESCRIPTION OF THE FIGURES

Other features and advantages of the invention will become apparent from the following detailed description, given by way of non-limiting example, with reference to the attached drawings in which:

The FIGURE shows a schematic cross-sectional view of an adhesive according to the invention.

### DETAILED DESCRIPTION OF THE INVENTION

The luminescent adhesive 1 for horology components according to the invention comprises a first layer 10 of an adhesive material, a second layer 11, referred to as the intermediate layer, comprising a binder loaded with between 10% and 80% by mass of a phosphorescent pigment emitting in the UVA spectrum, and a third layer 12 comprising a binder loaded with between 10% and 50% by mass of a phosphorescent pigment emitting in the visible spectrum.

The adhesive material used for the first layer is an adhesive material that allows the adhesive to be repositioned if necessary. Preferably, the adhesive material of the first layer is chosen among epoxy, acrylic, polyurethane or a rubber solvent.

The first layer has a thickness comprised between 20 μm and 200 μm, and preferably between 20 μm and 50 μm.

The second layer 11 of the adhesive comprises a phosphorescent pigment emitting in the UVA spectrum; this pigment exhibits an emission peak at a wavelength comprised between 300 nm and 400 nm.

The second layer has a thickness comprised between 50 μm and 500 μm, and preferably a thickness comprised between 200 μm and 300 μm. The second layer must be thick enough to be sufficiently opaque and reflective so as to force the pigments to be emitted towards the third layer.

Preferably, the phosphorescent pigment emitting in the UVA spectrum used for the second layer is a compound such as LiScGeO₄:Bi³⁺, LiYGeO₄:Bi³⁺, Sr₂MgGe₂O₇:Pb²⁺, NaLuGeO₄:Bi³⁺, or CaMgGeO₄:Bi³⁺.

The binder used for the second layer 11 and the third layer 12 is polyvinyl chloride or polyurethane.

The third layer has a thickness comprised between 50 μm and 500 μm, and preferably comprised between 150 μm and 250 μm.

Advantageously, the third layer has a thickness less than the thickness of the second layer to achieve sufficient transparency for UV rays to pass through to the second layer 11.

The phosphorescent pigment emitting in the visible spectrum used in the third layer is from the strontium aluminate family (SrₓAl_{y}O_{z}) spiked with europium (Eu2+) or dysprosium (Dy3+).

These various aspects of the invention provide a luminescent adhesive capable of giving off light for a longer period of time.

Of course, the present invention is not limited to the illustrated example and is open to various variants and modifications as will be apparent to the person skilled in the art, without departing from the scope of the invention as defined by the claims.

1. A luminescent adhesive (1) for horology components comprising:
a first layer (10) of an adhesive material;
a second layer (11), referred to as the intermediate layer, comprising a binder loaded with between 10% and 80% by mass of a phosphorescent pigment emitting in the UVA spectrum; and
a third layer (12) comprising a binder loaded with between 10% and 50% by mass of a phosphorescent pigment emitting in the visible spectrum.

2. The adhesive (1) according to claim 1, wherein the third layer (12) is semi-transparent to UV rays.

3. The adhesive (1) according to claim 1, wherein the first layer (10) is an epoxy, an acrylic, a polyurethane or a rubber solvent.

4. The adhesive (1) according to claim 1, wherein the phosphorescent pigment emitting in the UVA spectrum exhibits an emission peak at a wavelength comprised between 300 nm and 400 nm.

5. The adhesive (1) according to claim 1, wherein the first layer (10) has a thickness comprised between 20 μm and 200 μm.

6. The adhesive (1) according to claim 1, wherein the second layer (11) has a thickness comprised between 50 μm and 500 μm.

7. The adhesive (1) according to claim 1, wherein the third layer (12) has a thickness comprised between 50 μm and 500 μm.

8. The adhesive (1) according to claim 1, wherein the phosphorescent pigment emitting in the visible spectrum is strontium aluminate (SrAl₂O₄) spiked with europium (Eu²⁺) or with dysprosium (Dy³⁺).

9. The adhesive (1) according to claim 1, wherein the phosphorescent pigment emitting in the UVA spectrum is a compound such as LiScGeO₄:Bi³⁺, LiYGeO₄:Bi³⁺, Sr₂MgGe₂O₇Pb²⁺, NaLuGeO₄Bi³⁺, or CaMgGeO₄:Bi³⁺.

10. The adhesive (1) according to claim 1, wherein the second layer (11) has a thickness greater than that of the third layer (12).

11. The adhesive (1) according to claim 1, wherein the binder of the second layer (11) and of the third layer (12) is polyvinyl chloride or polyurethane
